(19) United States
(12) Patent Application Publication
(10) Pub. No.: US 2013/0325687 A1
(43) Pub. Date: Dec. 5, 2013

(54) METHODS AND ARRANGEMENTS FOR EXCHANGE TRADED PRODUCTS

(71) Applicant: The NASDAQ OMX Group, Inc., New York, NY (US)

(72) Inventor: David LAVALLE, Brooklyn, NY (US)

(73) Assignee: The NASDAQ OMX Group, Inc., New York, NY (US)

(21) Appl. No.: 13/888,445

(22) Filed: May 7, 2013

Related U.S. Application Data
(60) Provisional application No. 61/643,547, filed on May 7, 2012.

(51) Int. Cl. G06Q 40/04

(52) U.S. Cl. CPC G06Q 40/04
USPC 705/37

(57) ABSTRACT

In an automated exchange 410, while an order to trade an Exchange Trade Fund remains open, it is periodically checked whether a peg order price needs to be adjusted. Upon determination of a need for adjustment, a new peg order price correlated to a current quote of the Exchange Trade Fund can be calculated. This new peg order price is modified from said current quote according to predetermined trading criteria which involves a consideration of the Intraday Net Asset Value of the underlying index of the Exchange Trade Fund.

### TECHNICAL FIELD

The embodiments of the invention presented herein generally relate to securities markets. In particular, embodiments of the present invention relate to methods and arrangements such as automated exchanges, trading engines, computers and computer programs (software) for trading a financial instrument.

### BACKGROUND

When a seller and a buyer agree to a particular price for a financial instrument they complete a trade. I.e. they complete a verbal, or electronic, transaction involving one party buying a financial instrument from another party. The trades are typically initiated and completed by trading participants such as individuals, firms, dealers (who may be either individuals or firms), traders and brokers. Trading of financial instruments is generally performed on an exchange, i.e. a trading venue, and the trading is typically done through brokers, or traders, who buy or sell the financial instruments on behalf of the order owners. Thus, there are a variety of exchange participants which are coupled to the automated exchange through the members of the exchange. The term “financial instruments” is used herein in a broad sense and encompasses any tradable item i.e. securities, derivative or commodity, such as stocks, bonds, cash, swaps, futures, foreign exchange, options, gas electricity and so forth, or group of items that is traded through matching of counterparty orders (bid, offer).

An automated exchange typically receives order input data, in the form of data messages, from external devices used by traders, or brokers. The traders, or brokers, submit orders and/or quotes (or alterations/cancellations thereof) to the automated exchange for purposes of trading. In this context, an order is a request to sell or buy a financial instrument from any trading participant of the automated exchange and a “quote” may be an “offer” price, a “bid” price, or a combination of both an “offer” and “bid” price of a financial instrument, and is determined from quotations made by trading participants (or dealers).

The orders/quotes may relate to buying and/or selling of any type of financial instrument. In particular, the input data to the automated exchange can be an order data message (i.e. a data message comprising information element(s) identifying particulars about an order to sell or buy a financial article of trade) that represents the placing of a new bid or sell order, or a new quote. The order data message can also represent the change of an existing bid or sell order, or a quote. In addition, the order data message can represent a cancellation/change of an existing bid or sell order, or a quote. The order data message may be of a certain order type as will be further discussed below. Generally, order data messages, comprising an information element identifying an order, also comprises an information element identifying the order type and further information elements identifying the order owner etcetera. There exist various order types. These various order types can support passive trading strategies, aggressive trading strategies or a combination of both passive and aggressive trading strategies/approaches.

Passive trading strategies rely on the use of limit orders. A limit order is an order to buy a financial instrument at no more than a specific price, or to sell a financial instrument at no less than a specific price. For example, if a trader wishes to buy (sell) 1000 shares of company A, the trader may specify a maximum (minimum) price at which s/he is willing to buy (sell). This price is generally known as the limit price, and the order will remain pending until a counter party agrees to trade shares with the trader at this price. Typically traders will set the limit price to be at or below the current bid price for buy orders, and at or above the current offer price for sell orders. In these cases, the trader passively waits for the market to move in the trader's favor and for the trader's limit price to be accepted by a counter party. This approach gives the trader total control over the execution price, but no control over when, if ever, the order will execute.

Market orders are a buy or sell order to be executed immediately at current market price. A market order can therefore be said to support an aggressive trading strategy. A market order allows the trader to receive an immediate execution, but the trader loses control over the execution price. Also, large market orders may pose a problem because there may not be enough interest at the quoted market price to satisfy the complete order size. In this case, the execution may result in substantial market impact: a worsening of the execution price relative to the current quoted market price. If so, the trader who submits such a market order may have to pay a substantial premium for the right to execute the order with speed.

In view of the above, traders such as large institutional investors (e.g. mutual funds, hedge funds, etc.) may face a problem. On the one hand, they are trading large volumes, or blocks, of financial instruments and cannot afford to send large market orders that will result in market impact and inferior execution prices. On the other hand, they require a certain degree of speed to complete their trades within a defined time period.

Consequently, neither a purely passive nor a purely aggressive trading strategy is appropriate for these traders. This leads these traders to seek out improved strategies that use a combination of passive and aggressive approaches.

One such trading strategy is the so-called pegged order, or peg order. A pegged order, unlike conventional limit orders, automatically corrects its price according to movements in the quoted price. Typically a pegged buy order would be pegged to the bid, meaning that the order price is automatically adjusted to match the current quoted bid price. As counter parties (sellers) place marketable orders, those orders will execute first against the orders posted at the bid. By automatically maintaining an order price exactly at the bid, the pegged buy order is staying competitive relative to other passive buyers and therefore increasing the likelihood of an execution at a favorable price. Offsets allow a trader to peg an order with an incremental difference from the BBO (Best Bid Offer) and can be either positive (higher price) or negative (lower price). There are three types of pegged orders:
Primary Peg: Peg an order to the same side of the BBO.
Market Peg: Peg an order to the opposite side of the BBO.
Mid-point Peg: Peg an order to the mid-point of the BBO.

Pegged Orders have their price automatically adjusted by the automated exchange in response to changes in BBO prices.

Another trading strategy uses the discretion order. Discretion orders are basically regular limit orders, except that they introduce a second limit price. This second price (sometimes referred to as the discretion price) is the price at which the trader is willing to execute a trade aggressively. This is a selectively aggressive strategy in that it trades aggressively only when it is less expensive to do so, i.e. when spreads (the difference between the bid and ask) are narrow.

Yet another trading strategy is to combine pegging and discretion. For example, the trader could issue a buy order pegged to the bid with a 10 cent discretion range. This automatically adjusts the order price so that it always is equal to the current bid, and also automatically adjusts the discretion price so that it is always ten cents above the current bid. Thus the order receives all of the pegging advantages (staying competitive with other passive buyers) with all of the discretion advantages (ability to selectively trade aggressively in order to increase the likelihood of execution).

Exchange traded products (ETPs) such as Exchange Traded Funds (ETFs) are financial instruments that have become increasingly popular during the last 20 years. ETPs are one of the greatest financial innovations of our time and offer great value to, for example, retail and institutional investment communities. Moreover, they are one of the fastest growing financial instrument types in the world. ETPs offer transparency, liquidity, diversification, cost efficiency and investment flexibility to gain broad market exposure or to express a directional view as a core or satellite component to one's investment portfolio. ETPs do so while offering investment exposure to all asset classes-many of which would otherwise be inaccessible.

According to Blackrock's latest quarterly ETP Landscape Report dated March 31, 2012, there are over 4,400 ETPs listed globally, representing over $1.7 Trillion (USD) as compared to 297 ETPs representing $141 Million (USD) in 2002.

One example of an Exchange Traded Product is the Exchange Traded Fund, ETF, which is an investment fund traded on an automated exchange. In short, the structure of an ETF combines the benefits of an open ended mutual fund with the trading flexibility and execution cost efficiency of a cash equity. ETFs typically, although not always, are structured to track the performance of an underlying trust or index and therefore also offer traders greater investment transparency. An ETF is a financial instrument that offers traders access to multiple asset classes such as stocks, commodities, currencies and bonds. The performance of the ETF tracks the underlying portfolio trading close to its net asset value (NAV) over the course of the trading day. The NAV represents the total assets owned by the fund (i.e. the ETF) less the liabilities, divided by the number of shares outstanding.

ETFs can be bought and sold on an automated exchange and represent a collection of financial instruments and asset classes. Since an ETF can track the performance of an underlying portfolio, buying an ETF can provide traders with an efficient, transparent and cost-efficient tool/product offering exposure to the underlying securities. For example, instead of buying stocks in all companies that are included in an index, traders can be exposed to a diversified portfolio of the same stocks more efficiently and at a lower risk. Traders can invest in many industries, companies and asset classes accessing global markets with the purchase of just one financial instrument, i.e. the ETF.

Many ETFs are structured as index funds or to be fully transparent actively managed funds. In the former structure, the price of an ETF is based upon the price of the underlying index of the ETF. In the other structure of ETP's, the price of the ETP is based on the price of the underlying portfolio. Therefore, if the index or portfolio increases in value, so does the ETP/ETF and conversely, if the index or portfolio decreases in value, so does the ETP/ETF. Unfavorable executions can occur in the ETP/ETF marketplace and this is, at least partly, a result of traders not recognizing the trading characteristics of the tool/product (i.e. the ETP/ETF) that they are trading. Executions can occur with drastic variance from the NBBO (National Best Bid and Offer—sometimes only referred to as the BBO), and is usually, a result of traders relying on market orders for execution. NBBO is a term applying to the SEC (Securities and Exchange Commission) requirement and a key concept which assures that investors are getting the best price when buying or selling financial instruments. In principal, brokers must guarantee customers the best available ask price when they buy securities and the best available bid price when they sell securities. For instance, SEC Rule 605 requires market centers (exchanges) to disclose monthly data about the quality of their trade executions, and SEC Rule 606 specifies that broker-dealers that route orders on behalf of customers must prepare quarterly reports that disclose information.

More particularly, the existing ETP/ETF order is priced relative to the Intraday Net Asset Value (INAV) of the underlying index of the fund. INAV can also be represented as Intraday Optimized Portfolio Value (IOPV/IPV) or Intraday Indicative Value (IIV). INAVs are typically, but not necessarily, disseminated once every 15 seconds. Currently existing pegged orders only reference the current quote and/or quoted spread when determining the order's price. The inventor has realized that one could potentially use a market peg order (i.e. peg an order to the opposite side of the BBO). However, this would be making the assumption that the market has fairly priced the financial instrument relative to the ETF's INAV—which is, in fact, not always the case.

When trading in financial instruments, such as the ETP/ETF, trading participants have additional information available to them in the form of the INAV and trading participants often use the INAV to determine the quality of their execution—usually in the form of post trade analysis, i.e. analysis after completion of the trade. The trading participant can look at the time of execution and compare it to the prevailing INAV to analyze the quality of the execution. Theoretically, there should be minimal variance between the execution price and the INAV although this theory is dependent upon the type of product and the components of the underlying index. For example, an index composed of a basket of domestic cash equities would have a much tighter correlation (INAV to Price) than an index composed of a basket of locally domiciled global currencies.

### SUMMARY

It is with respect to above considerations and others that the various embodiments of the present invention have been made. It is therefore a general object of embodiments of the present invention to improve upon existing automated exchanges and to provide improved solutions that operate with fewer drawbacks than pre-existing automated exchanges and/or solutions. This object is addressed by the present invention as set out in the appended independent claims. Advantageous embodiments are recited in the appended dependent claims.
The inventor has realized that while the INAV is currently used by market participants predominantly as a post trade analysis tool, thus lending credence to its relevance as a benchmark for execution quality, no one has made available the dynamic use of the INAV to ensure the quality of the order execution at the time of order entry and execution. Consequently, the inventor proposes to link the INAV to the order entry/execution process.

Thus and according to a first aspect, a method of trading an Exchange Trade Product (ETP), such as an Exchange Trade Fund (ETF), is suggested. The method comprises: receiving, by an order processing module, a data message comprising an information element identifying an order to trade the ETP, said order having a peg order price; receiving periodically at a predetermined interval, by an INAV monitoring module, data messages from a data feed, the data messages comprising an information element identifying a current Intraday Net Asset Value, INAV; reading, by the INAV monitoring module, said information element to check whether the INAV has changed from a previously read information element identifying a previous INAV; transmitting, from the INAV monitoring module to the order processing module, a data message comprising the information element identifying the current INAV in response to a determination that the INAV has changed; receiving, by the order processing module, said data message comprising the information element identifying the current INAV; determining, by the order processing module, that there is a need of adjustment of the peg order price, and in response thereto modifying, by the order processing module, the peg order price in accordance with the current INAV received in the data message comprising the information element identifying the current INAV. The predetermined interval may be tied to an INAV update interval.

For example, the predetermined interval may be 0.5, 1, 5, 10, 15, 20, 25, 30, 45 or 60 seconds.

According to a second aspect, a trading engine for trading an Exchange Trade Product (ETP), such as an Exchange Trade Fund (ETF), is suggested. The trading engine may comprise an INAV monitoring module; and an order processing module. The order processing module is configured to receive a data message comprising in information element identifying an order to trade the ETP, said order having a peg order price. The INAV monitoring module is configured to periodically receive, at a predetermined interval, data messages from an external data feed, wherein the data messages comprise an information element identifying a current INAV. The INAV monitoring module is further configured to read said information element to check whether the INAV has changed from a previously read information element identifying a previous INAV. The INAV monitoring module is further configured to transmit, to the order processing module, a data message comprising the information element identifying the current INAV in response to a determination that the INAV has changed. The order processing module is configured to receive said data message comprising the information element identifying the current INAV. The order processing module is further configured to determine that there is a need of adjustment of the peg order price upon receiving said data message. Also, the order processing module is further configured to modify the peg order price in accordance with a current INAV received in the data message comprising the information element identifying the current INAV.

The predetermined interval may be tied to an INAV update interval.

In one example embodiment, the predetermined interval is 0.5, 1, 5, 10, 15, 20, 25, 30, 45 or 60 seconds. According to a third aspect, a computer-implemented method of trading an Exchange Trade Product/Fund (ETF) is suggested. The computer-implemented method of trading the Exchange Trade Product/Fund (ETF), comprises:

receiving by a computer a client request to trade the ETF,

forming by the computer an initial order to trade said ETF, said initial order having a peg order price being correlated to a current quote for said ETF,

sending said initial order to a trading engine where the ETF is traded,

while said initial order remains open, periodically checking at a predetermined interval said current quote to determine whether the peg order price needs to be adjusted,

upon determination of a need of adjustment, calculating by the trading engine a new peg order price correlated to a current quote of the ETF, said new peg order price being modified from said current quote according to predetermined trading criteria for said ETF, wherein said predetermined trading criteria comprises a consideration of the Intraday Net Asset Value (INAV).

The above-mentioned predetermined interval may preferably be tied to the INAV update interval, which is typically (but not necessarily) at least every 15 seconds. This way, as frequently as the INAV is updated it is checked whether the peg order price needs to be adjusted.

In some embodiments, the predetermined interval may for example be, but not limited to, 0.5 1, 5, 10, 15, 20, 25, 30, 45 or 60 seconds.

According to a fourth aspect, a computer-implemented method of trading an Exchange

Trade Product/Fund (ETF), comprises:

receiving by a computer a client request to trade the ETF,

forming by the computer an initial order to trade said ETF, said initial order having a peg order price being correlated to a current quote for said ETF,

sending said initial order to a trading engine where the ETF is traded.

This computer-implemented method of trading the ETF may be performed by a computer. The computer may be a client device or a trader terminal.

According to a fifth aspect, a computer-implemented method of trading an Exchange Trade Fund (ETF), comprises:

receiving an initial order to trade the ETF from a computer, said initial order having a peg order price being correlated to a current quote for said ETF,

while said initial order remains open, periodically checking at a predetermined interval said current quote to determine whether the peg order price needs to be adjusted,

upon determination of a need of adjustment, calculating a new peg order price correlated to a current quote of the ETF, said new peg order price being modified from said current quote according to predetermined trading criteria for said ETF, wherein said predetermined trading criteria comprises a consideration of the Intraday Net Asset Value (INAV).

The above-mentioned predetermined interval may preferably be tied to the INAV update interval, which is typically (but not necessirily) at least every 15 seconds. This way, as frequently as the INAV is updated it is checked whether the peg order price needs to be adjusted.

In some embodiments, the predetermined interval may for example be, but not limited to, 0.5 1, 5, 10, 15, 20, 25, 30, 45 or 60 seconds.

This computer-implemented method may be performed by a trading engine. The trading engine may be implemented as part of an automated exchange.

Also, an automated exchange system for trading an Exchange Trade Fund (ETF) can be provided. The automated exchange system may, e.g., involve one or more computers and a trading engine according to the below-mentioned fourth and fifth aspects.

According a sixth aspect, there is provided a computer for trading an Exchange Trade Fund (ETF). The computer for trading an Exchange Trade Fund (ETF), comprises processing logic configured to:

receive a client request to trade the ETF,

forming an initial order to trade said ETF, said initial order having a peg order price being correlated to a current quote for said ETF, and

send said initial order to a trading engine where the ETF is traded.

The computer may also comprise a memory.

The computer may comprise a user interface through which a user, typically a trader, can operate the computer to initiate client requests, such as the above-mentioned client request to trade an ETF.

The computer may comprise a receiver to receive messages. The computer may comprise a transmitter to transmit messages. The transmitter and the receiver may be implemented into a single transceiver for transmission and reception of messages. Thus, said initial order can be sent (i.e. transmitted) as a message from the computer to the trading engine via the transmitter or via a transceiver.

In some embodiments, the processing logic comprises an order forming module. In such embodiments, the order forming module is configured to execute the above-mentioned forming of the initial order to trade said ETF.

The computer may be a client device or trader terminal.

According to a seventh aspect, there is provided a trading engine for trading an Exchange Trade Fund (ETF). The trading engine for trading an Exchange Trade Fund (ETF) comprises processing logic configured to:

receive an initial order to trade the ETF, said initial order having a peg order price being correlated to a current quote for said ETF,

while said initial order remains open, periodically checking at a predetermined interval said current quote to determine whether the peg order price needs to be adjusted,

upon determination of a need of adjustment, calculating a new peg order price correlated to a current quote of the ETF, said new peg order price being modified from said current quote according to predetermined trading criteria for said ETF, wherein said predetermined trading criteria comprises a consideration of the Intraday Net Asset Value (INAV).

The above-mentioned predetermined interval may preferably be tied to the INAV update interval, which is typically (but not necessirily) at least every 15 seconds. This way, as frequently as the INAV is updated it is checked whether the peg order price needs to be adjusted.

In some embodiments, the predetermined interval may for example be, but not limited to, 0.5 1, 5, 10, 15, 20, 25, 30, 45 or 60 seconds.

The trading engine may also comprise a memory.

The trading engine may comprise a receiver to receive messages. The trading engine may comprise a transmitter to transmit messages. The transmitter and the receiver may be implemented into a single transceiver for transmission and reception of messages. Thus, said initial order can be received as a message from the computer to the trading engine via the receiver or via a transceiver.

In some embodiments, the processing logic comprises a determination module. In such embodiments, the determination module is configured to periodically check at a predetermined interval said current quote to determine whether the peg order price needs to be adjusted.

In some embodiments, the processing logic comprises a calculator module. In such embodiments, the calculator module is configured to calculate a new peg order price correlated to a current quote of the ETF, said new peg order price being modified from said current quote according to predetermined trading criteria for said ETF, wherein said predetermined trading criteria comprises a consideration of the Intraday Net Asset Value (INAV).

The trading engine may be implemented as part of an automated exchange.

### BRIEF DESCRIPTION OF THE DRAWINGS

Embodiments of the present invention will now be described in more detail, by non-limiting examples and with reference to the accompanying drawings, in which:

FIG. 1 illustrates an automated exchange for automated electronic trading of financial instruments;

FIG. 2 illustrates a block diagram of an embodiment of the present invention;

FIG. 3 illustrates a signaling diagram of signaling according to some embodiments of the invention;

FIG. 4 illustrates a flow chart depicting some procedural steps performed in accordance with an example embodiment of the present invention;

FIG. 5 illustrates a flow chart depicting procedural steps performed in accordance with an example embodiment of the present invention;

FIG. 6 illustrates a flow chart depicting procedural steps performed in accordance with an example embodiment of the present invention;

FIG. 7 illustrates an example implementation of an embodiment of the present invention;

FIG. 8 illustrates an example constitution, or format, of a data message including an order of a pegged order type;

FIG. 9 illustrates an example constitution, or format, of a data message including an INAV; and

FIG. 10 is a signaling diagram, or flow chart, depicting procedural steps performed in accordance with the example implementation of FIG. 7.

### DETAILED DESCRIPTION

In the following description, for purposes of explanation and not limitation, specific details are set forth such as particular architectures, interfaces, techniques, etc. in order to provide a thorough understanding of conceived embodiments of the present invention. Like reference numbers refer to like elements or method steps throughout the description.

In short, an aim with some embodiments of the present invention is to provide a novel and, also, improved order entry option when trading ETPs, such as ETFs. The proposed solution will allow for increased transparency and execution efficiency to traders/investors in a growing ETP industry and, thus, the ETF industry. Additionally, there may be a reduction of the number of erroneous executions and/or disadvantageous executions when trading ETPs, such as ETFs.

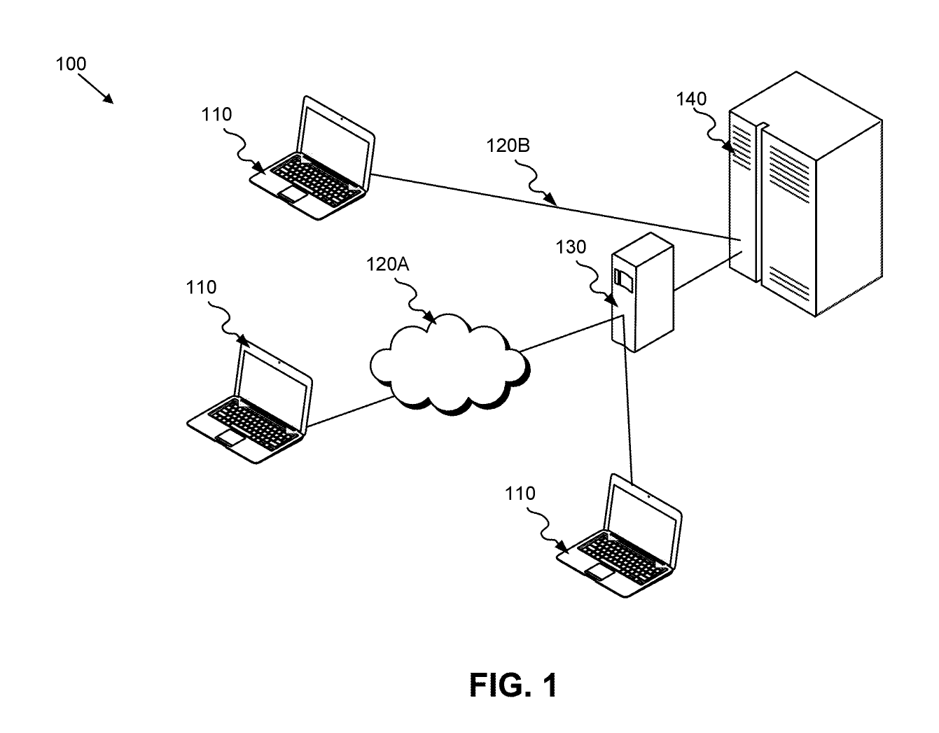

FIG. 1 illustrates an example automated exchange system 100 comprising computers in the form of trader terminals 110 that are used for issuing order data messages (herein also referred to as orders only), i.e. input data received by an automated exchange 140. The computers 110 are connectable, for example over the internet 120, or over some other connection means like a dedicated fiber 120B, to an electronic marketplace, e.g., the automated exchange 140. The automated exchange 140 can be hosted on a computer server or a cluster of computer servers. Sometimes, but not always, the computers 110 are connected to the automated exchange 140 through an entry gateway 130. The entry gateway 130 is connected to, or is being a part of, the automated exchange 140 and is configured to receive market actions, i.e. orders and/or quotes from the trader terminal/computer 110. An entry gateway 130 is usually in connection with the automated exchange 140 on a dedicated network and forwards the market actions to the automated exchange 140 and further usually broadcast updates back to the trader terminals/computers 110. It should however be understood that information being communicated to and from the automated exchange 140 and the trader terminals/computers 110 could be communicated via a single communication path. While the trading terminals/computers 110 in FIG. 1 are illustrated as computers that traditionally are associated with manual input of market actions, these can also be implemented as algorithmic trading units, sometimes termed automatic order generators, having manual input means for control of the algorithmic trading unit. The algorithmic trading unit is typically pre-programmed with instructions to automatically generate sell and buy orders and quotes (or changes/cancellations thereof) in response to input data received from the automated exchange 140. The trading terminals/computers 110 also represent trading participants inputting quotes to the automated exchange 140.

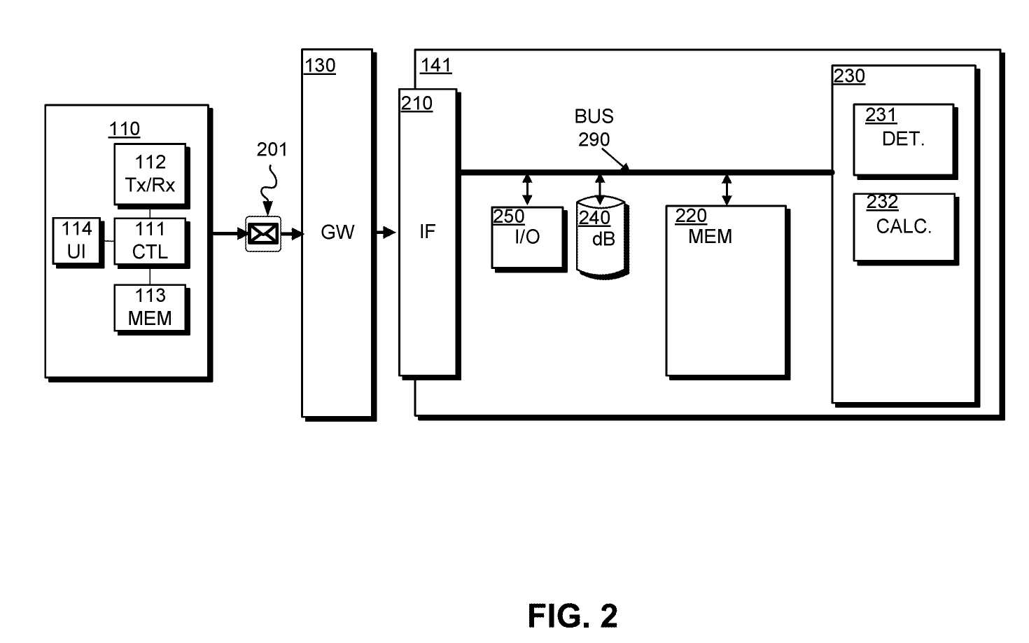

FIG. 2 illustrates a trading engine 141 according to an example embodiment of the invention. In said example embodiment, the trading engine 141 is configured for trading Exchange Trade Funds (ETFs). Or said differently, the trading engine 141 is a trading engine where ETFs are traded. The trading engine 141 may be implemented as part of the automated exchange 140. The trading engine 141 may be hosted on a computer server or a cluster of computer servers. The trading engine 141 comprises a processing logic 230, or processing logic circuitry. The trading engine 141 additionally typically comprises a memory 220 (e.g. a random access memory, RAM, or another non-volatile storage means), a storage memory 240 (e.g. a hard drive) and an input/output (I/O) controller 250, all coupled by a bus 290. The processing logic 230 may include a processor, microprocessor, an ASIC, FPGA, or the like. In some embodiments, the processing logic 230 may be implemented by a determination module 231 and a calculator module 232 as will be further detailed herein.

The trading engine 141 is configured to receive a message 201, i.e. a data message from a trading terminal/computer 110, optionally via a gateway 130. The trading terminal/computer 110 comprises processing logic 111, or processing logic circuitry. Furthermore, the trading terminal/computer 110 may additionally comprise a communication interface 112 with transmission (Tx) and/or reception (Rx) capabilities. To this end, the communication interface can be implemented as a transmitter, a receiver, or a combination of a transmitter and a receiver (i.e. a transceiver). The computer may also comprise a memory 113 (e.g., a RAM memory, or a non-volatile storage means).

An embodiment of trading an ETF will now be described with reference to FIG. 2. The processing logic 111 of the trading terminal/computer 110 is configured to receive a client (trading participant) request to trade the ETF. Typically, the client (trading participant) request is input by a trader to the trading terminal/computer 110 via a user interface (not shown) of the trading terminal/computer 110. Based on the client (trading participant) request, the processing logic 111 is configured to form an initial order to trade said ETF. In some embodiments, the processing logic 111 comprises an order forming module (not shown). If so, the initial order to trade said ETF can be executed and, thus, implemented by the order forming module of the processing logic 111. This initial order includes a value indicative of a peg order price, which is correlated to a value indicative of a current quote for said ETF. Furthermore, the processing logic 111 is configured to send (i.e. transmit) this initial order in the form of a message 201 (i.e. data message), via communication interface 112, to the trading engine 141, where the ETFs are traded.

The trading engine 141 is configured to receive the message 201. To this end, the trading engine may, e.g., comprise a communication interface 210. The communication interface may have both transmission (Tx) and reception (Rx) capabilities. To this end, the communication interface 210 can include a transmitter, a receiver, or a combination of a transmitter and a receiver (i.e. a transceiver). Upon receipt, the message 201 is then routed, typically via the interface device/module 210 of the trading engine 141 to the processing logic 230 thereof. In one example embodiment, the processing logic 230 comprises a determination module 231 and a calculator module 232. While said initial order remains open, the determination module 232 is configured to periodically check, at predetermined intervals, the above-mentioned current quote for said ETF to determine whether the peg order price needs to be adjusted. Typically, the predetermined interval is set to correspond to the Intraday Net Asset Value (INAV) update interval, which is typically (but not necessarily) at least 15 seconds. Upon determination of a need for adjustment, a calculator module 232 may be provided to calculate a new peg order price correlated to a current quote of the ETF. This new peg order price is typically modified from said current quote according to predetermined trading criteria for said ETF, wherein said predetermined trading criteria comprises a consideration of the Intraday Net Asset Value (INAV).

In some embodiments, the modules, components and interfaces discussed with reference to FIG. 2 can be implemented by hardware components, software components or a combination of hardware and software components.

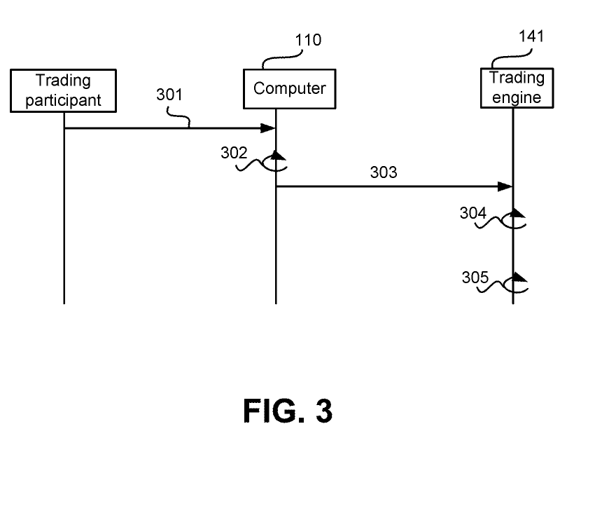

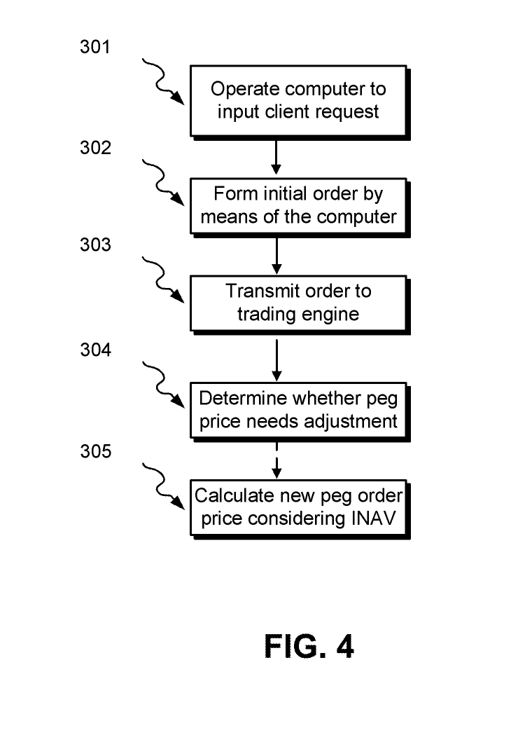

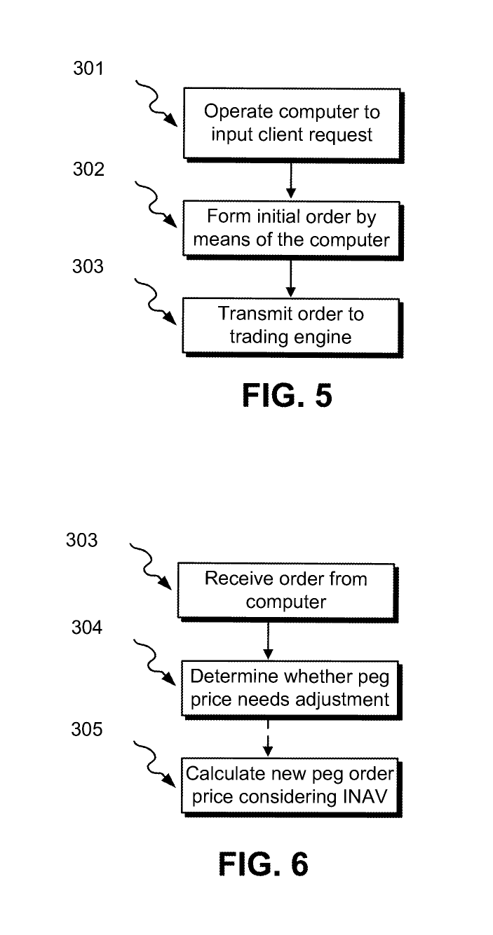

FIG. 3 illustrates a signaling diagram of a method for trading an Exchange Trade Fund (ETF) according to an embodiment of the invention. The method according to this example embodiment is also shown in the flow charts of FIGS. 4-6. This example method will now be described with reference to FIGS. 3-6. A user operates 301 his or her trading terminal/computer 110 to input a client (trading participant) request to trade an ETF. This client request is thus received, via input means, by the trading terminal/computer 110. Upon reception of the client request, the trading terminal/computer 110 forms 302 an initial order to trade said ETF. This initial order comprises a value indicative of a peg order price, which is correlated to a a value indicative of a current quote for said ETF. The trading terminanal/computer 110 transmits 303 said initial order to the trading engine 141, which is a trading engine where ETFs are traded. The trading engine 141 receives the initial order from the trading terminal/computer 110. While said initial order remains open, the trading engine 141 periodically checks at a predetermined interval said current quote to determine 304 whether the peg order price needs to be adjusted. Upon determination of a need for adjustment, the trading engine 141 calculates 305 a value indicative of a new peg order price which is correlated to a current quote of the ETF. This new peg order price is modified from said current quote according to predetermined trading criteria for said ETF, wherein said predetermined trading criteria comprises a consideration of the INAV.

The method described with reference to FIGS. 3-6 can be implemented by hardware, software or a combination of both hardware and software.

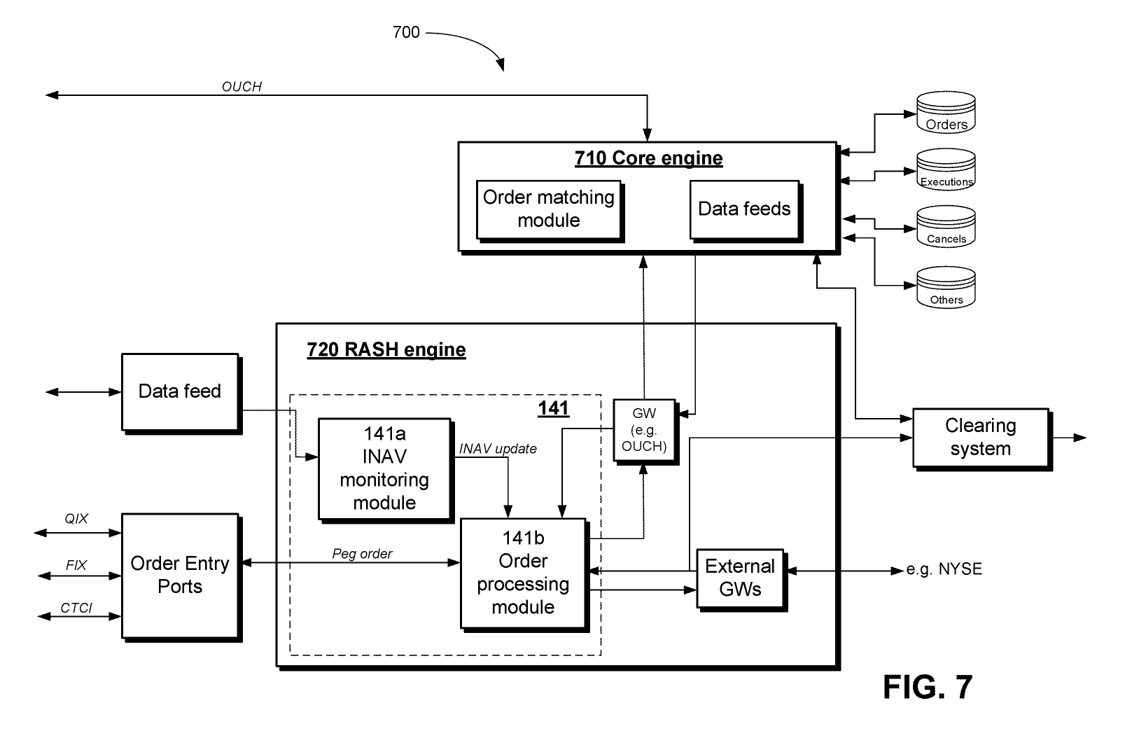

FIG. 7 illustrates an example implementation of an embodiment of the present invention. In this example implementation, the trading engine 141 is embodied as a part of an automated exchange 140, 700. In the detailed description with respect to FIG. 7, for purposes of explanation and not limitation, specific details are set forth in order to provide a thorough understanding of this example implementation. In some instances, detailed descriptions of well-known circuits, components and/or modules have been omitted so as not to obscure the description of the example with unnecessary detail. As can be seen in FIG. 7, the automated exchange comprises a core engine 710, including order matching processing logic and a RASH (Routing And Special Handling) engine 720. In this example, the trading engine 141 is embodied as an integral part of the RASH engine 720. As will be understood from the disclosure hereinbelow, the trading engine 141 is implemented by utilizing two modules, an INAV monitoring module 141a and a order processing module 141b. While these two modules are described as two separate modules, these two modules can alternatively be implemented as one single module with the same or essentially the same functionality.

The core engine 710 comprises at least one order book with stored order(s) that can be matched against incoming orders as is known in the art. It also comprises one or more data feeds, as illustrated and as known in the art. Data messages including orders may be submitted, or entered, directly to the core engine 710, e.g., by using the so-called OUCH protocol. Alternatively, data messages including orders may be submitted to the core engine 710 via the RASH engine 720 using a gateway, e.g. a so-called OUCH gateway (GW) using the OUCH protocol. The core engine 710 is configured to handle, i.e. process, data messages including orders of various order types. However, some order types (such as peg orders) may advantageously be submitted to the core engine 710 via the RASH engine 720. When orders have been accepted by the core engine 710, it returns (to trading terminal/computer 110 from which the data message including the order was received—not shown in FIG. 7—) a data message including order details along with the time stamp indicative of when the order was placed in the order book. The data message moreover includes details such as a unique order reference number, or other identification, assigned to the order by the core engine 710.

In this example implementation, the RASH engine 720 is an order processing module, which is specially configured for order entry and routing of messages, including orders of certain types such as peg orders. Data messages including orders may be entered via gateways according to various protocols, for example, the well-known FIX, QIX, CTCI and/or RASH protocols. The RASH engine 720 can be said to be in control of determining if, and when, to send routable data messages including orders to external market centers and/or when to post the order (included in the data message) in the order book of the core engine 710.

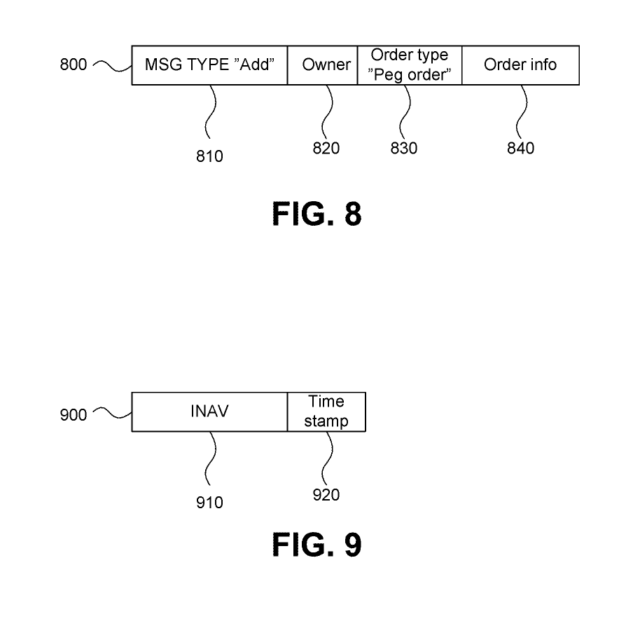

In FIG. 8 is illustrated an example embodiment in which a user transmits a data message 800 including an initial order to the RASH engine 720, e.g. via an order entry port. The data message 800 may, for example, be according, or similar, to a format as illustrated. That is, the data message 800 comprises one or several information elements 810-840. Each of the information elements 810-840 may for example be of one, two or more bytes. In this example, the data message 800 comprises a first information element 810 identifying the message type. Since the data message relates to a new peg order, the message type is MSG TYPE “Add” in this example. The second information element 820 identifies the user who submitted, i.e. transmitted, the data message 800. The third information element 830 identifies the order type, i.e. a peg order in this example implementation. The fourth information element 840 identifies order information, such as, price, quantity, time stamp, etcetera. In this example, the fourth information element 840 may also comprise information that the order is an order to trade an ETF. Here, the price indicated in the fourth information element 840 is generally correlated to a current quote of the ETF. In other words, the data message 800 including the initial order indicates that the order is a peg order and, furthermore, the peg order price (which is correlated to the tradable ETF).

The order processing module 141b is configured to receive, e.g. via an order entry gateway, the earlier-described data message 800 including the initial order to to trade the ETF. The order processing module 141 b will be further detailed hereinbelow.

In FIG. 9 is illustrated the INAV monitoring module 141a, which may be configured to receive, e.g. periodically with certain intervals (such as every 0.5, 1, 5, 10, 15, 20, 25, 30, 45 or 60 seconds), data messages 900 from an external data feed. The external data feed may be any appropriate market data feed that provides INAV, or updates of INAV. The received data messages 900 may, for example, comprise an information element 910 identifying a current INAV. Optionally, the data messages 900 may also comprise a time stamp along with the current INAV. The INAV monitoring module 141b is further configured to read said information element and more particularly the information element 910 identifying the INAV. This is advantageously performed periodically, e.g. every 0.5, 1, 5, 10, 15, 20, 25, 30, 45 or 60 seconds. Also, the INAV monitoring module 141b is configured to to check whether a current INAV has changed from a previously read information element identifying a previous INAV. This way, the INAV monitoring module 141b is configured to periodically monitor INAV based on input from the external data feeds. The INAV monitoring module 141a is configured to route, i.e. transmit, the data message 900 to the order processing module 141b. This way, the INAV monitoring module 141a can provide the order processing module 141 with updates about the INAV periodically.

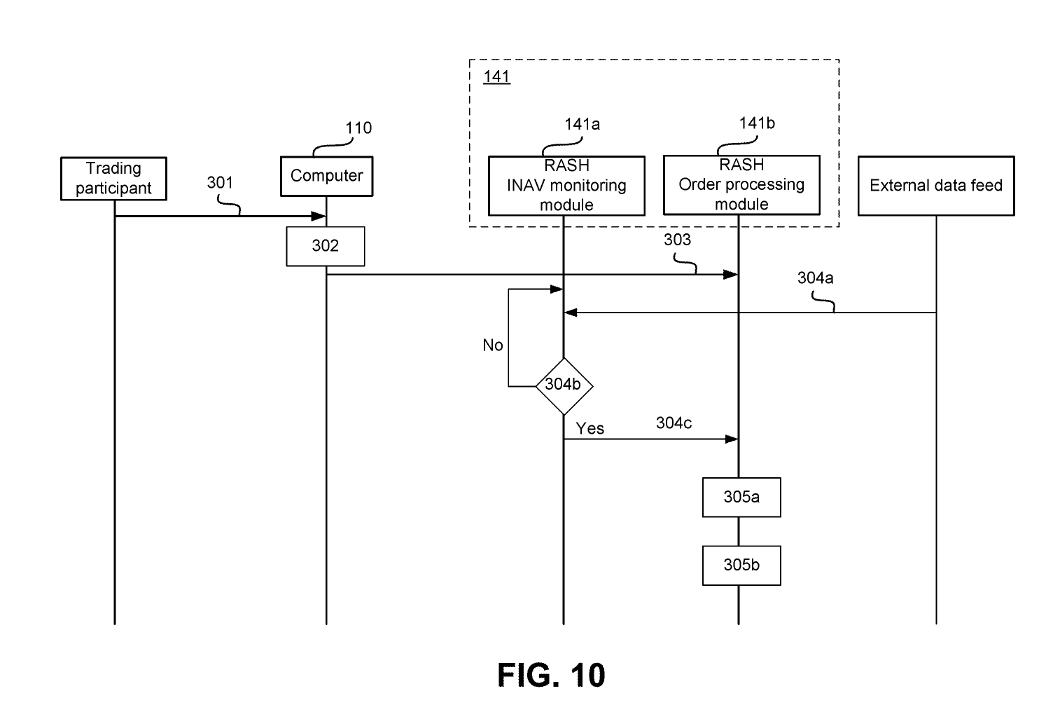

The order processing device/module 141b may be configured to receive, from the INAV monitoring device/module 141a, the earlier-described data message 900 comprising the information element identifying the current INAV. Upon receiving this data message 900 comprising the information element 910 identifying the current INAV, the order processing module 141b may be further configured to determine whether there is a need of adjustment of the peg order price of any pending (i.e. not yet matched) peg order. The order processing module 141b may thus additionally be configured to calculate a new peg order price in accordance with the current INAV received in the data message 900. As used herein, calculation of a new peg order price means that a previous peg order price is modified, or adjusted, in accordance with the current INAV. In other words, the peg order price of any received data messages including peg orders can be periodically changed to reflect changes of the INAV in the external marketplace.
FIG. 10 illustrates a signaling diagram of a method for trading an Exchange Trade Fund (ETF) when operating the example implementation shown in FIG. 7. A user operates 301 his or her trading terminal/computer 110 to input a client request to trade an ETF. This client request is thus received by the computer 110. Upon reception of the client request, the computer forms 302 an order to trade said ETF. The thus formed initial order may be a data message including one or more information elements as described hereinabove. The computer transmits 303 said order (or rather a data message including an information element identifying said order) to a RASH engine 710. More particularly, the data message including the order (in this example a peg order) is received 303 by the earlier-described RASH order processing module 141b.

Also, an INAV monitoring module 141a of the RASH engine periodically receives 304a INAV from external data feeds. The INAV monitoring module 141a can thus periodically check 304b whether the INAV has changed from a previously read information element identifying a previous INAV. If yes, i.e. if the INAV has changed (and thus been updated in the external marketplace), a data message comprising the information element identifying the new, i.e. the current, the INAV is transmitted 304c from the INAV monitoring module 141a to the order processing module 141b.

When the order processing module 141b has received said data message, the order processing module can determining 305a that there is a need of adjustment of the peg order price. In response thereto, the order processing module 141b modifies 305b, thus updates, the peg order price in accordance with the INAV newly received in the data message comprising the information element identifying the current INAV.

Various embodiments of the present invention may provide for a novel order type for trading ETFs in that it links the INAV to the order entry/execution process. While the INAV was used by market participants predominantly as a post trade analysis tool previously, no one had made available the dynamic use of the INAV to ensure the quality of the order execution at the time of order entry. According to various embodiments of the present invention, the price of an ETF order can be adjusted (thus, updated) as frequently as the INAV is adjusted (updated). This has the advantage that it allows traders to price their interests relative to the INAV regardless of where the market is pricing the fund. In turn, this will allow for improved execution of trades. For example, this new order type will allow trading participants to trade an ETF without having to concern about whether the value of the ETF's underlying index is drastically changing and, thus, resulting in inferior executions. In brief, it is believed that the various embodiments of the invention will allow for a reduction in the disparity between execution price and the underlying value of the fund, i.e. the ETF. Also, the various embodiments of the present invention present an intelligent way to enter an order to trade an ETF. As opposed to so-called “blind” order types where a trader buys at the prevailing prices, embodiments of the present invention allow for tying the order to a more reasonable price that relates to the actual value of the fund's components, i.e. the ETF's components.

The present invention may be embodied in other specific forms without departing from its spirit or essential characteristics. The described embodiments are to be considered in all respects only as illustrative and not restrictive. Accordingly, although the present invention has been described above with reference to specific embodiments, it is not intended to be limited to the specific form set forth herein. Rather, the invention is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Still further, reference signs in the claims are provided merely as a clarifying example and should not be construed as limiting the scope of the claims in any way. Also, all statements herein reciting principles, aspects, and embodiments disclosed herein, as well as specific examples thereof, are intended to encompass both structural and functional equivalents thereof. Thus, for example, it will be appreciated by those skilled in the art that block diagrams herein can represent conceptual views of illustrative circuitry or other functional units embodying the principles of the embodiments. Similarly, it will be appreciated that any flow charts and the like represent various processes which may be substantially represented in computer readable medium and so executed by a computer or processor, whether or not such computer or processor is explicitly shown. The functions of the various elements including functional blocks, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

We claim:

1. A method of trading an Exchange Trade Product, ETP, the method comprising:
receiving, by an order processing device, a data message comprising an information element identifying an order to trade the ETP, said order including a value indicative of a peg order price,
receiving periodically at a predetermined interval, by an INAV monitoring device, data messages from a data feed, the data messages comprising an information element identifying a current Intraday Net Asset Value, INAV;
reading, by the INAV monitoring device, said information element;
comparing, by a comparator, the read information element including the current INAV to a previously read information element identifying a previous INAV to check whether the INAV has changed from a previous INAV;
transmitting, from the INAV monitoring device to the order processing module, a data message comprising the received and read information element, identifying the current INAV, in response to a determination that the INAV has changed;
determining, by the order processing device, that there is a need of adjustment of the peg order price, and in response thereto
modifying, by the order processing device, the peg order price in accordance with the current INAV received in the data message comprising the information element identifying the current INAV.

2. The method of claim 1, wherein the predetermined interval is tied to an INAV update interval.

3. The method of claim 2, wherein the predetermined interval is 0.5, 1, 5, 10, 15, 20, 25, 30, 45 or 60 seconds.

4. The method of claim 1, wherein the ETP is an Exchange Trade Fund, ETF.

5. A trading engine for trading an Exchange Trade Product, ETP, the trading engine comprising:
an INAV monitoring device; and
an order processing device; wherein
the order processing device configured to receive a data message comprising an information element identifying an order to trade the ETP, said order having a peg order price,
the INAV monitoring device configured to periodically receive, at a predetermined interval, data messages from an external data feed, wherein the data messages comprise an information element identifying a current INAV;
the INAV monitoring device further configured to read said information element to check whether the INAV has changed from a previously read information element identifying a previous INAV;
the INAV monitoring device further configured to transmit, to the order processing device, a data message comprising the information element identifying the current INAV in response to a determination that the INAV has changed; and wherein
the order processing device further configured to determine that there is a need of adjustment of the peg order price upon receiving said data message; and wherein
the order processing device further configured to modify the peg order price in accordance with a current INAV received in the data message comprising the information element identifying the current INAV.

6. The trading engine of claim 5, wherein the predetermined interval is tied to an INAV update interval.

7. The trading engine of claim 6, wherein the predetermined interval is 0.5, 1, 5, 10, 15, 20, 25, 30, 45 or 60 seconds.

8. The trading engine of claim 7, wherein the ETP is an Exchange Trade Fund, ETF.

9. A computer-implemented method of trading an Exchange Trade Product, ETP, the method being performed by a computer and comprising:
receiving, by a processor of the computer, a client request to trade the ETP,
forming, by said processor, an initial order message including order instructions to trade said ETP, said initial order instructions having a peg order price being correlated to a current quote for said ETP,
transmitting, by a transmitter of said computer, the initial order message in the form of a data message to an ETF trading engine.

10. The computer-implemented method of claim 9, wherein receiving (301) the client request to trade the ETP further comprises:
receiving, via a user interface, the client request.

11. The computer-implemented method of claim 9, wherein the ETP is an Exchange Trade Fund, ETF.

12. A computer-implemented method of trading an Exchange Trade Product, ETP, the method being performed by a trading engine and comprising:
receiving, by a receiver, a data message comprising an initial order to trade the ETP, said initial order including a value indicative of a peg order price correlated to a value indicative of a current quote for said ETP,
while said initial order remains open, periodically checking, by a processor, at a predetermined interval said current quote to determine whether the peg order price needs to be adjusted,
upon determination of a need of adjustment, calculating a value indicative of a new peg order price correlated to a current quote of the ETF, said new peg order price being modified from said current quote according to predetermined trading criteria for said ETF, wherein said predetermined trading criteria comprises a consideration of the Intraday Net Asset Value, INAV.

13. The computer-implemented method of claim 12, wherein the predetermined interval is tied to an INAV update interval.

14. The computer-implemented method of claim 12, wherein the predetermined interval is 0.5, 1, 5, 10, 15, 20, 25, 30, 45 or 60 seconds.

15. The computer-implemented method of claim 12, wherein the ETP is an Exchange Trade Fund, ETF.

16. A computer for trading an Exchange Trade Product, ETP, the computer comprising:
a processing logic configured to:
receive a client request to trade the ETP; and
form an initial order to trade said ETP, said initial order having a peg order price being correlated to a current quote for said ETP, and
a communication interface configured to:
send said initial order in the form of a data message to a trading engine where the ETP is traded.

17. The computer of claim 16, further comprising a user interface through which a user can operate the computer to initiate client requests and wherein the processing logic is further configured to receive said client request via the user interface.

18. The computer of claim 16, wherein the processing logic comprises an order forming device configured to form the initial order to trade said ETP.

19. The computer of claim 16, wherein the computer is a client device or a trader terminal.

20. The computer of claim 16, wherein the ETP is an Exchange Trade Fund, ETF.

21. A trading engine for trading an Exchange Trade Product, ETP, the trading engine comprising:
a communication interface configured to
receive a data message comprising an initial order to trade the ETP, said initial order having a peg order price being correlated to a current quote for said ETP; and
a processing logic configured to
receive said initial order to trade the ETP,
while said initial order remains open, periodically check at a predetermined interval said current quote to determine whether the peg order price needs to be adjusted, and
upon determination of a need of adjustment, calculate a new peg order price correlated to a current quote of the ETP, said new peg order price being modified from said current quote according to predetermined trading criteria for said ETP, wherein said predetermined trading criteria comprises a consideration of the Intraday Net Asset Value, INAV.

22. The trading engine of claim 21, wherein the predetermined interval is tied to an INAV update interval.

23. The trading engine of claim 21, wherein the predetermined interval is 0.5, 1, 5, 10, 15, 20, 25, 30, 45 or 60 seconds.

24. The trading engine of claim 21, wherein the processing logic is configured to receive the initial order via an interface module.

25. The trading engine of claim 21, wherein the processing logic comprises a determination module configured to periodically check at a predetermined interval said current quote to determine whether the peg order price needs to be adjusted.

26. The trading engine of claim 21, wherein the processing logic comprises a calculator module configured to calculate the new peg order price correlated to a current quote of the ETP, said new peg order price being modified from said current quote according to predetermined trading criteria for said ETP, wherein said predetermined trading criteria comprises a consideration of the INAV.

27. The trading engine of claim 21, wherein the ETP is an Exchange Trade Fund, ETF.

28. An automated exchange, comprising a trading engine comprising:
a communication interface configured to:
receive a data message comprising an initial order to trade the ETP, said initial order having a peg order price being correlated to a current quote for said ETP; and
a processing logic configured to:
receive said initial order to trade the ETP,
while said initial order remains open, periodically check at a predetermined interval said current quote to determine whether the peg order price needs to be adjusted, and
upon determination of a need of adjustment, calculate a new peg order price correlated to a current quote of the ETP, said new peg order price being modified from said current quote according to predetermined trading criteria for said ETP, wherein said predetermined trading criteria comprises a consideration of the Intraday Net Asset Value, INAV.

29. A method of trading an Exchange Trade Product, ETP, comprising:
receiving, by a computer, a client request to trade the ETP,
forming, by the computer, an initial order to trade said ETP, said initial order having a peg order price being correlated to a current quote for said ETP,
sending, by the computer, said initial order in the form of a data message to a trading engine where the ETP is traded,
receiving, by the trading engine, said data message;
while said initial order remains open, the trading engine periodically checking at a predetermined interval said current quote to determine (304) whether the peg order price needs to be adjusted,
upon determination of a need of adjustment, calculating (305) by the trading engine a new peg order price correlated to a current quote of the ETP, said new peg order price being modified from said current quote according to predetermined trading criteria for said ETP, wherein said predetermined trading criteria comprises a consideration of the Intraday Net Asset Value, INAV.

30. The method of claim 29, wherein the step of receiving (301) the client request to trade the ETP comprises: receiving the client request via a user interface of the computer.

31. The method of claim 29 wherein the predetermined interval is tied to an INAV update interval.

32. The method of claim 29, wherein the predetermined interval is 0.5, 1, 5, 10, 15, 20, 25, 30, 45 or 60 seconds.

33. The computer-implemented method of claim 29, wherein the ETP is an Exchange Trade Fund, ETF.

34. A system for trading an Exchange Trade Product, ETP, the system comprising a computer and a trading engine, wherein:
the computer is configured to receive an initial order to trade said ETP, said initial order having a peg order price being correlated to a current quote for said ETP,
the computer is configured to send said initial order in the form of a data message to a trading engine where the ETP is traded,
the trading engine is configured to receive said data message;
the trading engine is configured to, while said initial order remains open, periodically check at a predetermined interval said current quote to determine whether the peg order price needs to be adjusted,
the trading engine is configured to, upon determination of a need of adjustment, calculate by the trading engine a new peg order price correlated to a current quote of the ETP, said new peg order price being modified from said current quote according to predetermined trading criteria for said ETP, wherein said predetermined trading criteria comprises a consideration of the Intraday Net Asset Value, INAV.

35. The system of claim 34, wherein the ETP is an Exchange Trade Fund, ETF.
